(19) United States
(12) Patent Application Publication
(10) Pub. No.: US 2014/0263014 A1
(43) Pub. Date: Sep. 18, 2014

(54) Water Filtration Device

(71) Applicant: Primeau Water Filter Partnership, Dallas, TX (US)

(72) Inventor: Ronald T. Moser, Penn Valley, CA (US)

(73) Assignee: Revelations Water Technologies Holding Company, Inc., Dallas, TX (US)

(21) Appl. No.: 13/833,835

(22) Filed: Mar. 15, 2013

(51) Int. Cl. C02F 1/00

(52) U.S. Cl. CPC C02F 1/002
USPC 210/202

(57) ABSTRACT

A simplified portable water purification system provides an unfiltered water receiving compartment, a disposable filter cartridge, and a filtered water reservoir all in a single container. The container has a removable lid and is a vertically positioned, wide-mouth, tubular structure. The disposable filter cartridge is horizontally positioned centrally and divides the container into the two compartments. Contaminated and unfiltered water poured into the top receiving compartment of the container gravitates through filtering materials in the disposable filter cartridge. Filtering materials include a media stabilization plate having substantially vertical perforations therethrough for containing iodinated resin. An embodiment includes a vent system that allows backwashing of the filter element.

### CROSS REFERENCE TO RELATED APPLICATIONS

None.

### FIELD OF THE INVENTION

This invention relates to systems and equipment for water purification. Embodiments of the invention are particularly directed towards a simplified portable water purification system. The simplification is accomplished in embodiments of the present invention by providing an unfiltered water receiving compartment, a disposable, multi-stage filter cartridge, and a filtered water reservoir all in a single container.

### BACKGROUND OF THE INVENTION

The water filtration device disclosed herein provides solutions to problems inherent in the related art including flow rate of water through filters and filter media contact efficacy. Embodiments of this device utilize a novel combination of iodinated resins in a media stabilization plate to kill and eliminate bacteria and viruses on contact. The structure of the filtering device and the mechanics applied to accomplishing filtration provide novelty for embodiments of the present invention.

### SUMMARY OF EMBODIMENTS OF THE INVENTION

Embodiments of the present invention provide a new and improved water filter. To overcome deficiencies in related art, the present invention provides a simple and effective water filtering system that can be confined to a single container. The container is a vertically positioned cylindrical structure having a downwardly end sealed to a base as a part thereof and an upwardly end wide-mouthed with a removable handled lid, the structure useful for the containment of water. In embodiments described herein, the container is divided into upper and lower compartments by a centrally placed, horizontally positioned disposable filter cartridge. The upper compartment of the container typically serves as the unfiltered water receiving compartment. The interior of the container contains a support edge for the disposable filter cartridge which divides the container into an upper and lower compartment. The lower compartment serves as the water recovery and reservoir compartment. The centrally fitted disposable filter housing contains filtering materials which are retained in the disposable filter cartridge structure in part by a flow-regulating apertured cover. The flow-regulating apertured cover allows the unfiltered water to gravitate into and through the filtering material encased in the disposable filter cartridge.

The filtering materials encased in the disposable filter cartridge include at the least, a media stabilization plate having substantially vertical perforations for containing iodinated resins, and two fabric filters. The unique configuration of the media stabilization plate allows the filter media, iodinated resin, to be compartmentalized. Compartmentalization allows the flow of water to be directed specifically to and through the filter media while keeping sections of filter media separate. The filter efficiency is improved by controlling the flow through the filter media. Unfiltered water is prevented from flowing from the upper compartment to the lower compartment unless it travels through the filtration paths defined by the openings containing the filter media.

One embodiment of the water filter device includes a venting system that allows the water filter device to be turned upside down to allow water to travel from the filtered water compartment to the unfiltered water compartment. The venting system in this embodiment includes a means to seal the top of the vent when the water filter is turned over thus allowing water to travel in a reverse direction across the filter media.

Therefore, it is a desired object of this invention to overcome limitations in the design of related art devices by incorporating an unfiltered water receiving compartment, a disposable multi-stage filter cartridge that includes a media stabilization component and a filtered water recovery and reservoir compartment all in a single portable container.

Other objects and the many advantages of the present invention will become better understood from reading the following specification and comparing the numbered parts described with like numbered parts illustrated in the drawings.

### BRIEF DESCRIPTION OF DRAWINGS

The invention is illustrated in the following drawings.

FIG. 1 is an exploded view of an embodiment of a water filter device.

FIG. 2 shows another exploded view of an embodiment of the water filter device.

FIG. 3 shows a section view of an embodiment of a water filter.

FIGS. 4 and 5 show section views of an embodiment of a water filter device.

FIG. 6 shows an enlarged view of a section of the FIG. 4 drawing.

### DETAILED DESCRIPTION OF A PREFERRED EMBODIMENT

FIGS. 1 and 2 show an embodiment of a single cylinder water filter device. The filter device 10 has a body 12 that includes an upper chamber 14 that can accept and temporarily hold unfiltered water. In practical application, the unfiltered water is gravity fed through a filter component 30. Filtered water from the filter component is stored in the lower chamber 16. A water spigot 18 is utilized to deliver the filtered water. Typically the filter device will include a lid 20, handle 22 and a support stand 24. In the embodiment shown in FIG. 1, a vent attachment 26 allows air to travel from the lower chamber area to the outside.

FIG. 3 shows an embodiment of a filter component 30 with a handle 32 and lid 34 attached to a filter basket or body 36. The filter component consists of several stages of filtration media enclosed within or a part of the filter basket. Stage 1 is typically a protective influent water dispensing screen 34 (which also acts as the lid to the filter basket 36). This lid is attached to the filter basket and in one embodiment can be sonic welded to the filter basket body. This protective influent screen provides direction and dispersion for the influent water, while also providing protection from large heavy particles that could otherwise penetrate into the filter media inside the filter basket.

Stage 2 is a single one to five micron filter 38. This stage is utilized to filter out organisms as small as one to five microns, such as giardia, cyst and particulate matter. This is a fabric membrane filter that can be made of cloth, synthetic plastic or paper.

Stage 3 is comprised of iodinated resins 40 in a media stabilization plate 42. Stage 3 acts to kill and eliminate bacteria and viruses on contact. This stage utilizes a solid media stabilization plate 42 with openings or chambers (also at 40). The holes (chambers) in the stabilization plate also keep the iodinated resins from shifting or moving about and allow all the water flow to come into contact with these resins. The holes or chambers holding the iodinated resins also provide some control of the flow rate to enhance filtration. The media stabilization plate is “solid” in that the top portion of the plate is non-porous in the areas surrounding the openings or chambers.

Stage 4 is comprised of a one to five micron filter 46 affixed to the bottom of the stabilization plate to keep the iodinated resins separated and prevent them from falling through the openings (chambers) and interfering with media below it. This filter is a single one to five micron filter affixed to the bottom of the media stabilization plate, as utilized in stage 2, which provides filtration of residual particulate media (resin) and further control of the rate of water through the filter device.

Stage 5 includes an ion-exchange resin media 48 (including dual ion exchange resins). This stage filters dissolved solids and large molecular organic compounds.

Stage 6 provides an activated carbon (granular and/or non-granular) media 50. This stage filters organic chemicals, such as Volatile Organic Chemicals (VOC's), chlorine and improves taste and odor.

Stage 7 provides a one to five micron fabric membrane filter 52. This step ensures that no particulate from Stage 4 and 5 can pass through.

Stage 8 is an effluent dispensing plate 54 which also acts as the bottom part of the filter basket (basket which holds all of the filtering media). The dispensing plate evenly disperses the effluent water into the bottom, filtered water-holding chamber of the container.

FIG. 4 shows a side cutaway view of an embodiment of the water filter device. The filter basket 30 is illustrated without all of the stages or layers of filter media for clarity. The filter basket is set into position against the inside surface of the container body that is tapered. A gasket or O-ring 58 typically acts to provide a seal between the upper chamber 14 and the lower chamber 16. The vent 26 provides a path for airflow between the opening 64 in the body and the top of the vent under the vent hood 62.

The embodiment illustrated in FIG. 4 includes a vent component with means to block the flow of fluids through the upper vent opening under the vent hood 62 when the water filter device is turned upside down. The vent means illustrated in FIG. 4 utilizes a vent ball 74 that rests on the bottom of the vent shaft when the filter device is in an upright position. The vent ball does not obstruct the lower vent opening 72 when the ball rests on the bottom of the vent shaft.

The vent ball 74 travels to seal off the upper vent 70 when the water filter device is turned upside down sealing off the discharge of water directly to the outside of the container. This is useful to utilize the backwash capability of this embodiment. The backwashing of the filter media can be accomplished when the lower water compartment contains a sufficient amount of water. By turning the water filter device upside down, the water flow is directed through the filter media in a reverse direction and helps to flush contaminants through the filter media.

FIG. 5 shows another cutaway view of an embodiment of the water filter device.

FIG. 6 shows an enlarged view of an embodiment of the air vent mechanism shown in FIG. 4.

### CONCLUSIONS, OTHER EMBODIMENTS, AND SCOPE OF INVENTION

Embodiments of the water filter system disclosed herein utilize a solid media stabilization plate with substantially vertical openings or chambers that hold the media (iodinated resins) in place. The “opening, holes or chambers” holding the iodinated resins can be configured with different diameters, depths and configurations to hold different amounts of iodinated resins depending on the contaminant one is trying to eliminate. The openings also serve to compartmentalize the media. This compartmentalization allows the unfiltered fluid to be channeled into one of these segregated pathways and increases the efficacy of the filtration.

Over time, fluid traveling through a filter media can cause channeling within the media. A channel can be defined as a defined pathway for fluid through the media often via the path of least resistance. Filter media will compact over time (through flow and gravity) and decrease the effectiveness of the media. A void is sometimes created by compaction of the media. Channeling will occur and the water will find the path of least resistance. Fluid traveling along a channel will not contact as much media surface as fluid traveling through less compacted media. The efficacy of the filtration through less compacted media increases in part due to the increase of contact between the fluid and the filter media.

Another embodiment disclosed herein utilizes a novel vent component that allows the filter assembly to have “backwash capability”. The cylinder type filter canister and filter element configuration, with upper and lower chambers separated by a seal, allows backwashing to be accomplished simply by turning the filter upside down, then opening the spigot to let air in and letting the water that is in the lower chamber (now on top) flow backwards. This process can be repeated as often as the user deems it necessary.

Backwashing has several benefits. It expands the filter media (water goes in a different direction and fluffs the media, thus providing more contact with media) exposing more surface area, reducing or eliminating channeling and thereby giving the filter element more life. The flow of water is improved by expanding the filter media. Backwashing also removes some of the contaminants and sediment accumulated in and/or on the filter media.

Furthermore, to enhance the “backwash capability”, the vent is designed with a fluid flow obstruction component (small stainless steel ball valve, for example) inside the vent, which blocks the water from escaping through the upper portion of the vent when the filter assembly is turned upside down, thereby giving the filter element a more vigorous backwash by increasing the down flow water pressure. There are several variations of fluid flow obstruction components contemplated and a ball valve is just one example.

Embodiments of the filtration system have been described herein in the context of water filtration. The system should not be construed as limited to filtration of water however because it could be utilized to filter other fluids containing contaminants.

The above description presents the best mode contemplated in carrying out embodiments of the invention. However, it is susceptible to modifications and alternate constructions of the embodiments shown in the drawings and accompanying description. Consequently it is not intended that the invention be limited to the particular embodiments disclosed. On the contrary, the invention is intended to cover all modifications, sizes and alternate constructions falling within the spirit and scope of embodiments of the invention.

What is claimed is:

1. A filter system comprising:
a cylindrical filter housing;
an influent dispensing screen affixed to the top of the cylindrical filter housing;
an effluent dispensing screen affixed to the bottom of the cylindrical filter housing;
filter media contained within the cylindrical filter housing in between the influent and effluent dispensing screens, the filter media including at least:
a media stabilization plate having vertical perforations therethrough for containing iodinated resin;
a first micron filter layer; and
a second micron filter layer.

2. The filter system of claim 1, wherein the filter media further includes:
a resin filter block adapted for ion exchange with a liquid;
a carbon filter block; and
a third micron filter layer.

3. The filter system of claim 2 further including:
an elongate annular body for retaining the cylindrical filter housing therein, the annular body oriented vertically to contain liquid.

4. The filter system of claim 3, wherein the position of the cylindrical filter housing forms an upper reservoir in the annular body for containing unfiltered liquid and a lower reservoir in the annular body for containing filtered liquid.

5. The filter system of claim 2, wherein the influent and effluent dispensing screens are affixed to the cylindrical filter housing by ultrasonic welding.

6. The filter system of claim 2, wherein the micron filter layers within the cylindrical filter housing are one or a combination of paper, fabric, and plastic filters.

7. The filter system of claim 4 further comprising:
an elongate tubular vent having an upper portion and a lower portion and a flow obstruction component disposed therein, the tubular vent affixed to the annular body in vertical orientation, the lower portion communicating via an opening through the wall of the annular body below the upper reservoir, the upper portion having an opening smaller than the inside diameter of the tubular vent enabling restricted liquid flow from the inner tube to the atmosphere;
wherein upon turning the filter system upside down via the annular body, liquid from the lower reservoir flows into the tubular vent but is retained therein by the flow obstruction component causing the remaining liquid in the lower reservoir to pass back through the filter media and into the upper reservoir effectively back washing the filter media.

8. The filter system of claim 1 further including:
an elongate annular body for retaining the cylindrical filter housing therein, the annular body oriented vertically to contain liquid.

9. The filter system of claim 8, wherein the position of the cylindrical filter housing forms an upper reservoir in the annular body for containing unfiltered liquid and a lower reservoir in the annular body for containing filtered liquid.

10. The filter system of claim 9 further comprising:
an elongate tubular vent having an upper portion and a lower portion and a flow obstruction component disposed therein, the tubular vent affixed to the annular body in vertical orientation, the lower portion communicating via an opening through the wall of the annular body below the upper reservoir, the upper portion having an opening smaller than the inside diameter of the tubular vent enabling restricted liquid flow from the inner tube to the atmosphere;
wherein upon turning the filter system upside down via the annular body, liquid from the lower reservoir flows into the tubular vent but is retained therein by the flow obstruction component causing the remaining liquid in the lower reservoir to pass back through the filter media and into the upper reservoir effectively back washing the filter media.

11. The filter system of claim 7, wherein the flow obstruction component is a ball that is heavier than the liquid filtered.

12. The filter system of claim 11, wherein the upper portion of the tubular vent is shielded by a hood.

13. The filter system of claim 10, wherein the flow obstruction component is a ball that is heavier than the liquid filtered.

14. The filter system of claim 13, wherein the upper portion of the tubular vent is shielded by a hood.

15. The filter system of claim 4, wherein the cylindrical filter housing has an O-ring seal disposed about the perimeter thereof at or below the influent dispensing screen, the O-ring seal forming a seal against the inside wall of the annular body preventing fluid from bypassing the filter media.

16. The filter system of claim 9, wherein the cylindrical filter housing has an O-ring seal disposed about the perimeter thereof at or below the influent dispensing screen, the O-ring seal forming a seal against the inside wall of the annular body preventing fluid from bypassing the filter media.
